(19) United States
(12) Patent Application Publication
(10) Pub. No.: US 2026/0324646 A1
(43) Pub. Date: Oct. 22, 2026

(54) BIOLOGICAL COMPOSITION FOR USE AGAINST PLANT FUNGICIDAL INFECTIONS

(71) Applicant: UNIVERSITA' DEGLI STUDI DI MILANO, Milano (IT)

(72) Inventors: Caterina LA PORTA, Milano (IT); Marianna NTOUROU, Milano (IT)

(21) Appl. No.: 19/484,631

(22) PCT Filed: May 15, 2024
(86) PCT No.: PCT/IB2024/054726

§ 371 Date: Nov. 14, 2025

(30) Foreign Application Priority Data
May 15, 2023 (IT) 102023000009750

(51) Int. Cl. A01N 59/14; A01N 37/36; A01N 59/08; A01P 3/00

(52) U.S. Cl. CPC A01N 59/14; A01N 37/36; A01N 59/08; A01P 3/00

(57) ABSTRACT

Fungicidal compositions including citric acid and calcium chloride for preventing the development of fungal infections in crop plants are applied to the crop plants by spraying. The crop plants are grown in fields, greenhouses or in hydroponic systems.

The present patent application is applied in the agricultural filed, and in particular in preventing fungal infections in crop plants.

The cultivation of plants for food use such as tomatoes, weather in a field or under more controlled circumstances, such as hydroponics, is subject to significant diseases, including fungal infection.

In addition to having a significant impact on the growth of the plants themselves, this involves high management costs.

According to FAOSTAT statistics, Italy is in sixth place as world producer of tomatoes, with 6,248 million tons.

Italy is in the forefront, with a large number of Italian companies operating in different international markets, for producing tomatoes by virtue of hydroponic technology.

The hydroponic production system is a state-of-the-art technology, which ensures high-quality vegetables free of residues year-round and multiple productivity in specially developed greenhouses and in controlled climatic conditions during summer and winter.

Tomatoes are the ideal choice for hydroponic cultivation.

The constant overall demand for tomatoes allows commercial growers to easily recoup the costs of equipment and labor required for hydroponic technology.

The tomatoes growing within hydroponic systems are however susceptible to several diseases, in particular fungal diseases.

Among the fungal diseases, the one called “downy mildew” is the most harmful, capable of causing a reduction in the quantity and quality of the tomato crop.

Early downy mildew is caused by phytopathogenic fungi belonging to the genus Alternaria, mainly from the species Alternaria tomatophila, Alternaria alternata and Alternaria solani.

Alternaria is a large and complex genus with a global distribution in soil, air and various other types of habitats.

It mainly consists of saprophytic and phytopathogenic species, which cause pre- and post-harvest damage to agricultural products, including tomatoes, potatoes, eggplants and apples.

The species Alternaria are capable of producing secondary metabolites, such as phytotoxins, which carry out an essential role in plant pathogenesis.

Early downy mildew disease develops on tomatoes at moderate to warm temperatures (15 to 30° C.), while air currents and sprays of water are the main cause of spreading the spores of the pathogen.

The symptoms of downy mildew on tomatoes occur on the fruit, stem, and foliage.

In the open field, the spores of the pathogen overwinter in the infected plant debris and soil.

Therefore, part of the general good practices for preventing early downy mildew disease is represented by the removal of weeds, leaving enough space between the plants and ensuring crop rotation every 2-3 years.

Several synthetic liquid fungicides and pesticides are available for preventing and controlling the disease in the early stages thereof.

Similar chemical treatments are used in hydroponic cultivation to prevent the spread of pathogenic fungi.

However, the widespread use of synthetic fertilizers and pesticides is known to have negative effects on the environment and human health; moreover, the development of resistant pathogenic strains has already been noted.

Therefore, in recent decades, research has focused on alternatives to conventional fungicides for the so-called biocontrol.

US patent application US 2005/096393 describes a composition with antifungal activity for treating plants, which exploits the synergy between surfactants, such as sodium dioctyl sulfosuccinate or sodium lauryl sulfate, and sorbates, at acidic pH by virtue of the use of citric acid.

### SUMMARY OF THE INVENTION

The inventors of the present patent application have surprisingly developed a solution for combating fungal infections in plants.

### OBJECT OF THE INVENTION

In a first object, the present invention describes the use of a composition of citric acid and calcium chloride for preventing fungal infections in plants.

In a particular aspect, such a composition can further comprise boric acid.

In a further detail, the use is on tomato plants.

In another detail of the invention, the cultivation of the plants is hydroponic.

The compositions for the described uses themselves represent further objects of the present invention.

### BRIEF DESCRIPTION OF THE DRAWINGS

FIG. 1 shows the results of in vitro assays on the growth of the pathogens Alternaria spp and Botrytis caroliniana.

FIG. 2 shows the results of in vivo assays on S. lycopersicum plants infected with the pathogenic fungi Alternaria spp 8 days from infection.

### DETAILED DESCRIPTION OF THE INVENTION

In accordance with a first object, the present patent application describes the use of a composition of citric acid and calcium chloride for preventing fungal infections in plants.

For the purposes of the present patent application, a described composition comprises citric acid or a salt thereof or a mixture of salts thereof.

For example, sodium citrate can be used.

In a preferred aspect, the citric acid is obtained by microbial fermentation.

More in particular, the citric acid is used in a concentration of about 30-70 mM and preferably about 50 mM.

For the purposes of the present invention, the described composition comprises calcium chloride (CaCl₂).

For the purposes of the present invention, the calcium chloride is comprised in a concentration of about 0.4-1 mM and preferably about 0.7 mM.

According to an embodiment of the invention, the described composition further comprises boric acid (H₃BO₃).

In a preferred aspect, the boric acid is obtained from fruit or vegetables.

More in particular, the boric acid is used in a concentration of about 2-4 mM and preferably about 3 mM.

The compositions of the invention are aqueous solutions.

According to an even more particular aspect, the citric acid, as defined above, and the boric acid, as defined above, are in a ratio of about 50:3 or 16:1.

According to a preferred aspect, plants which can be treated in accordance with the present invention include: tomatoes (Lycopersicon esculentum), potatoes, carrots, strawberries, peppers, eggplants.

The treatment described by the present patent application is a preventive treatment.

By this is meant that the plant is treated with a composition of the invention before the fungus develops after infection has occurred.

According to a preferred aspect of the invention, the preventive treatment is repeated at regular intervals of about 4-10 days and preferably 4-8 days, after infection.

The application of the compositions of the invention is carried out by spraying.

For the purposes of the present patent application, the treatment is preventive against a fungus selected from the group comprising: Alternaria sp. and Botrytis caroliniana.

In particular, a composition according to the invention can be used for the prevention of the invention of a fungus selected from the group comprising: Alternaria tomatophila, Alternaria alternata and Alternaria solani.

According to a first aspect of the invention, the described compositions are applied to a plant grown in an open field or in a greenhouse.

In accordance with a preferred aspect of the invention, the described compositions are applied to a plant grown according to hydroponic or traditional technology (i.e., in a field or in the greenhouse).

As indicated above, the compositions described above themselves represent further objects of the present invention.

### Materials and Methods

All the chemicals used are natural products or produced by microorganisms.
Citric acid (CA, C₆H₈O₇), Mr=210.14 g/mol (Sigma-Aldrich, Steinheim, Germany).
Boric acid (BA, H₃BO₃), Mr=61.83 g/mol (Sigma-Aldrich).
Calcium chloride (CaCl₂6H₂O), stock solution: 0.2191 g/mL (BDH Chemicals Ltd Poole, UK).

The compositions of the invention are aqueous mixtures.

In particular:
Composition 1 contains CA and CaCl₂.
Composition 2 contains CA, CaCl₂ and BA.

The phytopathogenic fungus Alternaria sp. was isolated in December 2021 from a vineyard in Oltrepo pavese (Santa Maria della Versa, Pavia, Italy).

When necessary, Alternaria sp. is also isolated from infected tomato plants from this research, using a cork drill.

In addition to Alternaria sp., experiments were also carried out on the fungus Botrytis caroliniana.

The fungal strains were maintained on potato dextrose agar (PDA, Merck kGaA, Darmstadt, Germany) at 4±1° C. and regularly subcultured. Plants of Solanum lycopersicum (cultivar Rio Grande) were sprouted in the greenhouse of the Fondazione dell'Università di Milano Filarete (Milan, Italy) under controlled conditions (T=18/25±1° C. (night/day), humidity ≥90%, photoperiod 16 h light:8 h dark). Determination of in vitro growth inhibition caused by mixtures of CA, BA, CaCl₂ and the compositions of the invention was performed by measuring the diameter and calculating the radial growth rate (Kr, mm/h). The diameter growth of the fungi was determined daily, in six repetitions, using the Image J program (Copyright© 1993, 2018, Oracle).

### Example 1

### In Vitro Experiments

The fungal cultures were carried out in Petri dishes (6 Well Cell Culture Plates, Sigma-Aldrich). The media treated with the compositions of the invention were inoculated with mycelial caps (diameter 7 mm) of growing active fungal strains (e.g., Alternaria sp. and B. caroliniana). The control cultures are carried out on PDA support and compared with those conducted on CA, BA, CaCl₂ and on compositions according to the invention. The media was sterilized at 121° C. for 20 min. Incubation was carried out at 27±1° C. for 12 days in a static incubator (Memmert GmbH+Co. KG, Schwabach, Germany).

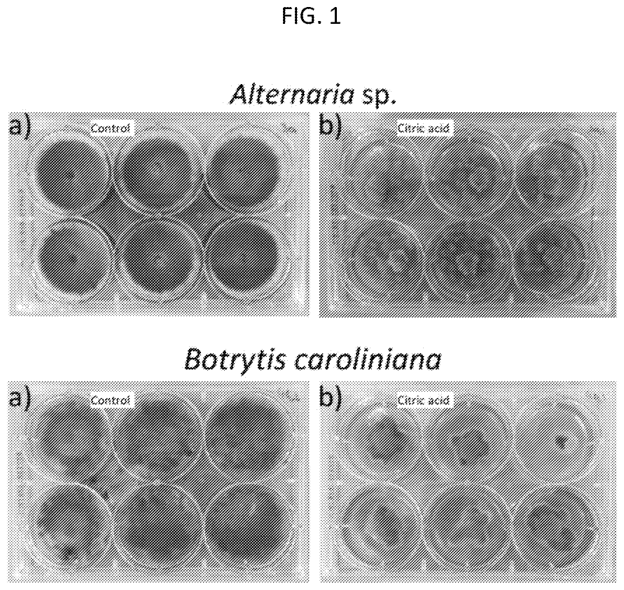

The results are shown in FIG. 1 (a) PDA control; b) PDA substrate containing citric acid). The Table below shows the results of all the combinations and individual elements.

| | | Kr | Effect (12 days from |
|---|---|---|---|
| test no. | Sample# | (mm/h) | cultivation) |
| 1 | PDA (control) | 0.176 | +++++ |
| 2 | CA 1X (0.01M) | 0.099 | ++++ |
| 3 | CA 2X (0.02M) | 0.028 | +++ |
| 4 | CA 3X (0.03M) | 0.034 | +++ |
| 5 | CA 5X (0.05M) | 0.012 | + |
| 6 | CA 7X (0.07M) | 0.020 | ++ |
| 7 | CA 10X (0.1M) | 0.000 | − |
| 8 | CA 105X (1M) | 0.000 | − |
| 9 | BA 1X (1.6 mM) | 0.115 | ++++ |
| 10 | BA 3X (4.8 mM) | 0.051 | +++ |
| 11 | BA 5X (8.0 mM) | 0.003 | − |
| 12 | CaCl₂ 1X (0.45 mM) | 0.214 | +++++ |
| 13 | CaCl₂ 2X (0.90 mM) | 0.221 | +++++ |
| 14 | CaCl₂ 3X (1.4 mM) | 0.077 | ++++ |
| 15 | CA 5X + BA 3X | 0.001 | − |
| 16 | BA 3X + CaCl₂ 1X | 0.060 | ++++ |
| 17* | CA 5X + CaCl₂ 1X | 0.014 | + |
| 18** | CA 5X + BA 3X + CaCl₂ 1X | 0.001 | − |

+++++: no effect on fungus growth;
−: strong inhibition of fungus growth
*composition 1 according to the invention
**composition 2 according to the invention

The data in the Table show that the compositions of test no. 17 and 18 exert an inhibitory activity on the fungus growth.

### Example 2

### In Vivo Experiments

S. lycopersicum plants were infected by sterilizing the spores of the pathogenic fungus Alternaria sp. on the attached leaves and stem. Alternaria sp. spores were obtained by dropping 20 mL of sterile H₂O into a culture of the fungus in a Petri dish. The inoculum was calculated after enumerating the spores under light microscope using a counting chamber device and the concentration was 3.1×10⁶ spores/mL. 24 hours after infection, the attached leaves were sprayed with the compositions of the invention. The plants were infected and untreated, or treated with CA mixtures or with the compositions of the invention 24 hours after infection with Alternaria sp. In some cases, 8 days after treatment with CA mixtures or with the compositions of the invention, the plants were reinfected with Alternaria sp. spores. The plants infected with S. lycopersicum were left to grow in the greenhouse. The experiments were repeated in triplicate.

| | | Effect (8 days after |
|---|---|---|
| test no. | sample | infection) |
| 1 | untreated (control) | +++++ |
| 5 | CA 5X | ++ |
| 10 | BA 3X | Toxic for the plant |
| 15 | CA 5X + BA 3X | Toxic for the plant |
| 16 | BA 3X + CaCl₂ 1X | +++ |
| 17 | CA 5X + CaCl₂ 1X | − |
| 18 | CA 5X + BA 3X + CaCl₂ 1X | + |

+++++: onset of symptoms;
−: no symptoms

The data in the Table above show that the compositions of test no. 17 and 18 show the best activity while preserving the plant.

### Example 3

### Preventive Effect

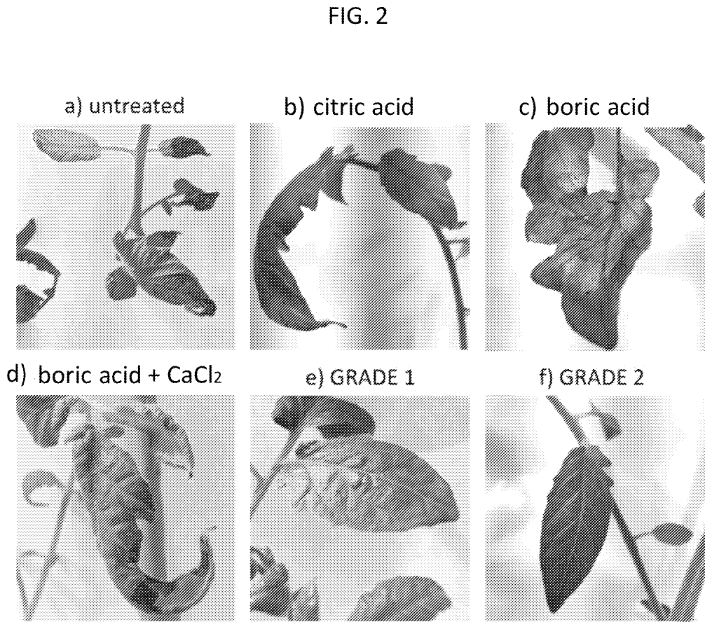

The preventive effect of the compositions of the invention was tested during the in vivo growth of the plant. Attached leaves infected with S. lycopersicum were treated with the solutions of the invention, asymptomatic until the eighth day after treatment, they were reinfected with spores of Alternaria sp. The plants were left to grow in the greenhouse. Two days after re-infection, the first symptoms begin to be visible; therefore, the composition of the invention is reapplied every week to prevent further infections. The results are shown in FIG. 2.

The advantages of the composition of the invention will be immediately apparent from the description of the composition as reported above.

Firstly, the invention makes use of the possibility of using products of natural origin, as they are obtained from microbial synthesis. The use and spread of synthetic compounds which are harmful to the environment is thus avoided.

Moreover, citric acid is widely used in the food industry and already approved by the EU (E330).

Therefore, the invention fits well in the development projects of green and sustainable agriculture as required by the new Green Deal of the European Community.

Moreover, although particularly advantageous for cultivation by hydroponic technology, the same strategy can also be used in the open field.

The compositions described have been shown to prevent fungal infections without damaging the treated plants.

1. A method for preventing fungal infections in plants, the method comprising applying to the plants a composition comprising citric acid and calcium chloride, wherein the citric acid is in a concentration of about 30-70 mM, and said wherein the calcium chloride is in a concentration of about 0.4-1 mM.

2. The method of claim 1, wherein the citric acid is in a concentration of about 50 mM.

3. The method of claim 1, wherein the calcium chloride is in a concentration of about 0.7 mM.

4. The method of claim 1, wherein the composition further comprises boric acid.

5. The method of claim 4, wherein the boric acid is in a concentration of about 2-4 mM.

6. The method of claim 4, wherein the citric acid and the boric acid are in a ratio of about 50:3.

7. The method of claim 1, wherein the fungal infections are caused by a fungus selected from the group consisting of: Alternaria tomatophila, Alternaria alternata, Alternaria solani, and Botrytis caroliniana.

8. The method of claim 1, wherein the plants are selected from the group consisting of: tomato, potato, carrot, strawberry, pepper, and eggplant.

9. The method of claim 1, wherein the composition is applied to the plants by spraying.

10. The method of claim 1, the method further comprising repeating the applying of the composition to the plants every 4-10 days after infection.

11. The method of claim 1, wherein the plants are grown in a field, a greenhouse or a hydroponic system.

12. A fungicidal composition comprising citric acid and calcium chloride for prevention of fungal infections in plants, wherein the citric acid is in a concentration of about 30-70 mM, and wherein the calcium chloride is in a concentration of about 0.4-1 mM.

13. The fungicidal composition of claim 12, wherein the citric acid is in a concentration of about 50 mM.

14. The fungicidal composition of claim 12, wherein the calcium chloride is in a concentration of about 0.7 mM.

15. The fungicidal composition of claim 12, wherein the composition further comprises boric acid.

16. The fungicidal composition of claim 15, wherein the boric acid is in a concentration of about 2-4 mM.

17. The fungicidal composition of of claim 15, wherein the citric acid and the boric acid are in a ratio of about 50:3.

18. The method of claim 4, wherein the boric acid is in a concentration of about 3 mM.

19. The method of claim 1, the method further comprising repeating the applying of the composition to the plants every 4-8 days after infection.

20. The fungicidal composition of claim 15, wherein the boric acid is in a concentration of about 3 mM.
